(19) United States
(12) Patent Application Publication
(10) Pub. No.: US 2004/0218046 A1
(43) Pub. Date: Nov. 4, 2004

(54) Digital camera performing image transmission and method thereof

(75) Inventor: Tae-yol Kim, Seongnam-si (KR)

Correspondence Address: GARDNER CARTON & DOUGLAS LLP, ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 10/792,449

(22) Filed: Mar. 3, 2004

(30) Foreign Application Priority Data
Apr. 30, 2003 (KR) 2003-27538

(51) Int. Cl. H04N 5/225

(52) U.S. Cl. 348/207.1

(57) ABSTRACT

A digital camera and method of controlling a digital camera is provided. In the method, when the user enters data of an electronic mail address book in the menu mode, the data of the electronic mail address book is received and stored. When the user selects a recipient from the electronic mail address book in the menu mode, recipient information regarding the selected recipient is stored. When an image file is acquired through photographing in the photographing mode, the acquired image file, storage path information regarding the stored image file, and the recipient information are stored. When the digital camera is connected to a communication network in one of the photographing and menu modes, the image file is transmitted to the recipient according to the storage path information and the recipient information.

This application claims priority to Korean Patent Application No. 2003-27538, filed on Apr. 30, 2003, in the Korean Intellectual Property Office, the disclosure of which is incorporated herein in its entirety by reference.

### BACKGROUND

The present invention relates to a digital camera and method of controlling a digital camera, and more particularly, to a digital camera that operates in a menu mode or photographing mode selected by a user and processes image files acquired by the user's photographic operations in the photographing mode.

According to a typical digital camera, for example, a digital camera disclosed in U.S. Pat. No. 6,167,469, a user needs to enter electronic mail (e-mail) addresses of destinations and select image files to be transmitted every time he/she sends image files stored in the digital camera via e-mail.

Therefore, the user is inconvenienced when sending image files stored in the digital camera via e-mail and cannot transmit the image files quickly.

### SUMMARY OF THE INVENTION

The present invention provides a camera and method that allows a user to conveniently operate a digital camera and quickly send image files stored in the digital camera via electronic mail (e-mail).

According to an aspect of the present invention, there is provided a method of controlling a digital camera which operates in menu and photographing modes according to a user's selection and processes image files acquired through photographing in the photographing mode. In the method, from the menu mode the user may enter an electronic mail address which is received and stored an electronic mail address book. When the user selects a recipient from the electronic mail address book in the menu mode, recipient information regarding the selected recipient is stored. When an image file is acquired through photographing in the photographing mode, the acquired image file, storage path information regarding the stored image file, and the recipient information are stored. When the digital camera is connected to a communication network in one of the photographing and menu modes, the image file is transmitted electronically based upon the storage path information and the recipient information.

According to the present invention, stored image file path information and recipient information to which the image file is to be sent are stored in the digital camera. Accordingly, when the digital camera is connected to a communication network in the photographing or menu mode, the image file is transmitted to the recipient. Accordingly, a user can conveniently operate the digital camera and quickly send image files stored in the digital camera via e-mail.

### BRIEF DESCRIPTION OF THE DRAWINGS

The above and other features and advantages of the present invention will become more apparent by describing in detail preferred embodiments thereof with reference to the attached drawings in which:

FIG. 1 is a block diagram showing a state where a digital editing apparatus is connected to a digital camera according to an embodiment of the present invention;

FIG. 2 is a flowchart of an overall control algorithm of a controller of the digital camera shown in FIG. 1, according to an embodiment of the present invention;

FIG. 3 is a flowchart of a menu mode program shown in FIG. 2;

FIG. 4 is a flowchart of a transmission control program shown in FIG. 3;

FIG. 5 is a block diagram showing a structure of an address book file that is received from the digital editing apparatus shown in FIG. 1 and primarily stored in a memory card;

FIG. 6 is a block diagram showing a state where recipient is added to the address book file shown in FIG. 5;

FIG. 7 is a block diagram showing an example of recipient information in the address book file shown in FIG. 6;

FIG. 8 is a flow chart of a photographing mode program shown in FIG. 2;

FIG. 9 is a flow chart of a storage control program shown in FIG. 8;

FIG. 10 is a diagram showing an example of new transmission information added to a transmission information file according to step S322 shown in FIG. 9; and

FIG. 11 is a diagram showing an example of transmission information to be deleted in step S214 shown in FIG. 4 according to step S213 shown in FIG. 4.

### DETAILED DESCRIPTION OF THE INVENTION

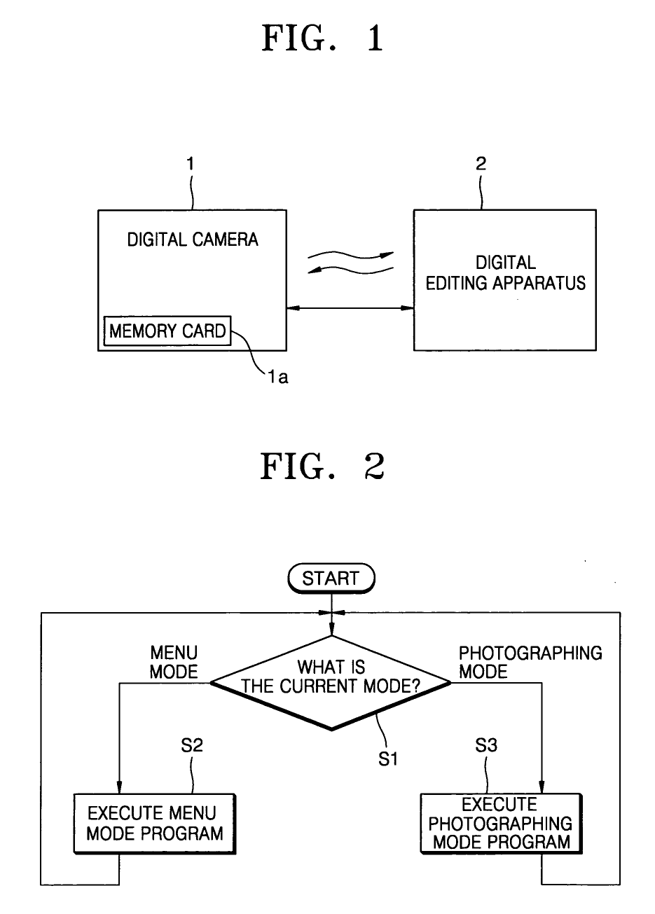

Referring to FIG. 1, a memory card 1a can be inserted into and removed from a digital camera 1 according to an embodiment of the present invention. The digital camera 1 stores user data, communication data, and image files acquired through photographing in the memory card 1a. The user data is received from a user input unit (not shown) of the digital camera 1. The communication data includes an electronic mail (e-mail) address book received from a digital editing apparatus 2, for example, a personal computer (PC) or a personal digital assistant (PDA). When the digital camera 1 is connected to a communication network (not shown), the communication data also includes data received from the communication network. The communication network can be connected to the digital camera 1 through the digital editing apparatus 2.

FIG. 2 shows a basic control algorithm of a controller (not shown) of the digital camera 1 shown in FIG. 1, according to an embodiment of the present invention. When a menu mode is selected by a user in step S1, a menu mode program is executed in step S2. When a photographing mode is selected by the user in step S1, a photographing mode program is executed in step S3.

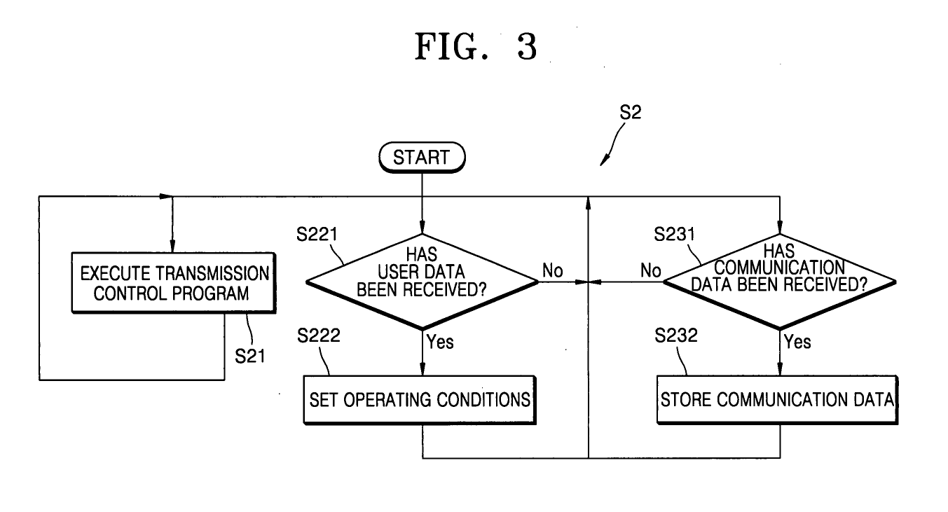

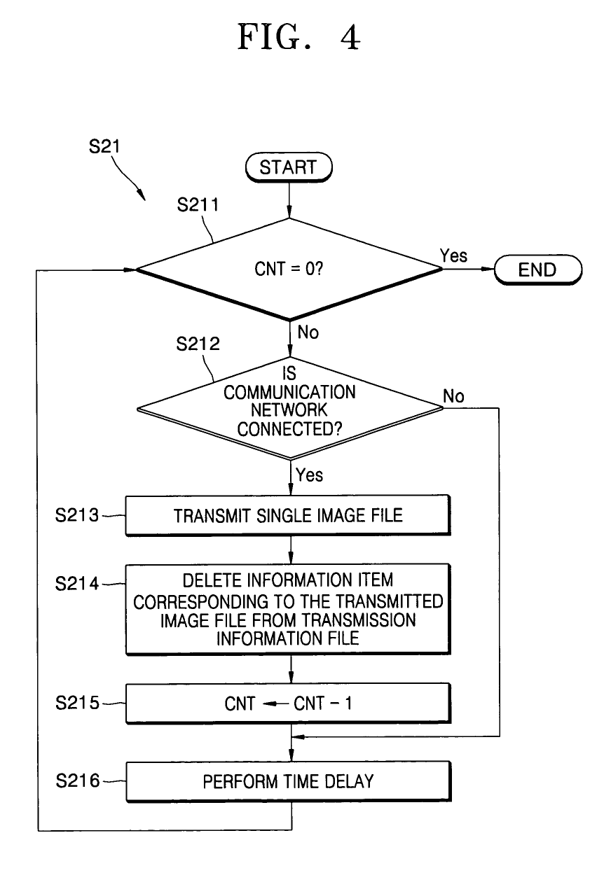

Referring to FIGS. 1 and 3, according to the menu mode program shown in FIG. 2, a transmission control program is continuously executed in step S21. A detailed algorithm of the transmission control program will be later described with reference to FIG. 4. In the meantime, when user data is received from a user input unit (not shown) in step S221, operating conditions corresponding to the user data are set in step S222. When communication data is received from the digital editing apparatus 2 or a communication network in step S231, the communication data is processed and stored in the memory card 1a in step S232.

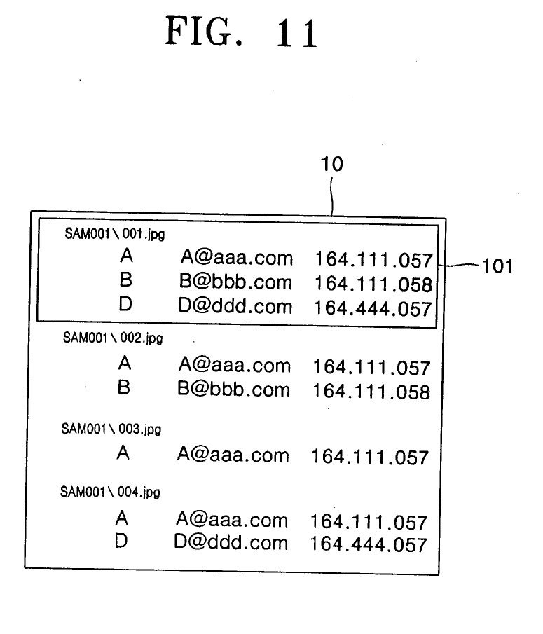

The transmission control program executed in step S21 shown in FIG. 3 will be described with reference to FIGS. 1, 2, 4, 10, and 11.

In step S211, (FIG. 4) the number CNT of transmission information items in a transmission information file 10 is detected. When there are any transmission information items, the transmission control program is continued. When there are no transmission information items, the transmission control program ends.

When there are any transmission information items in step S211, it is determined whether the communication network has been connected in step S212. The communication network may be directly connected, to the digital camera 1 or may be indirectly connected, through a wired or wireless connection to the digital camera 1 through the digital editing apparatus 2. When it is determined in step S212 that the communication network has been connected, the transmission control program is continued. Otherwise, when it is determined in step S212 that the communication network is not connected, the transmission control program returns to the initial step S211 after a time delay is performed in step S216.

When it is determined that the communication network is connected in step S212, a single image file is transmitted to a recipient's e-mail address according to the order in which image files are stored in the transmission information file 10 in step S213. Next, an information item 101 corresponding to the image file transmitted in step S213 is deleted from the transmission information file 10 in step S214. Next, the number CNT of transmission information items is decremented in step S215. Next, a time delay is performed for a predetermined period of time in step S216, and then the transmission control program returns to the initial step S211.

Accordingly, when the digital camera 1 is connected to the communication network in a standby mode, each image file can be quickly transmitted to an e-mail address corresponding thereto based on the transmission information file 10. Creation of the transmission information file 10 will be later described in detail. The transmission control program executed in step S21 is included in the photographing mode program executed in step S3, and therefore, an image file acquired through photographing can be immediately transmitted when the digital camera 1 is connected to the communication network in the photographing mode.

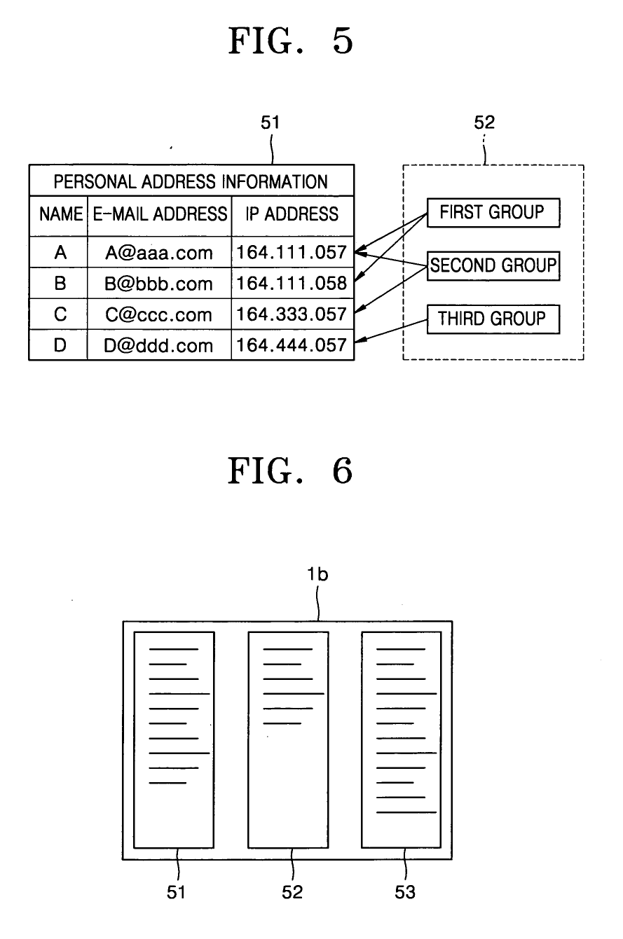

FIG. 5 shows a structure of an address book file that is received from the digital editing apparatus 1 shown in FIG. 1 and may be stored in the memory card 1a. Referring to FIGS. 1 and 5, a user can edit personal address information 51 and group information 52 in the digital editing apparatus 2 and transmit them to the digital camera 1. More specifically, recipients' names and e-mail addresses and names of recipients in each group are transmitted to the digital camera 1. Then, a controller of the digital camera 1 stores the personal address information 51 and the group information 52 as an address file, e.g., an “address.dat” file, in a folder, e.g., a “Temp” folder, in the memory card 1a in steps S231 and S232 shown in FIG. 3. Here, the group information 52 may be comprised of an index of locations where addresses of individuals belonging to a group are stored (rather than maintaining duplicate address information for the group). Accordingly, a storage area for the group information 52 can be minimized.

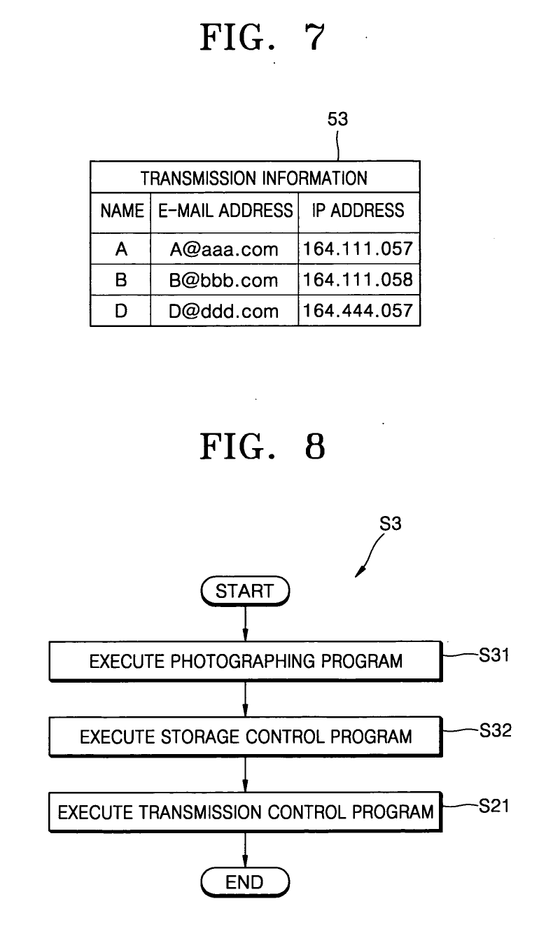

FIG. 6 is a block diagram showing the address book file displayed on a display panel 1b of the digital camera 1 after recipient information 53 is added to the address book file shown in FIG. 5. FIG. 7 is a block diagram showing an example of the recipient information 53 in the address book file shown in FIG. 6. The recipient information 53 can be created or deleted according to steps S221 and S222 in the menu mode program executed in step S2 shown in FIG. 3.

The following description concerns an example of a procedure for creating the recipient information 53. A user selects a recipient from the personal address information 51 and/or the group information 52 using the up, down, left, and right buttons of the digital camera 1 in the standby mode before photographing. Next, if the user presses the OK button of the digital camera 1, the recipient information 53 is created based on address information in association with the selected recipient.

The following description concerns an example of a procedure for deleting the recipient information 53 from the address book file. A user selects a recipient from the recipient information 53 using the up, down, left, and right buttons of the digital camera 1 in the standby mode before photographing. Next, if the user presses the delete button of the digital camera 1, address information in association with the selected recipient is deleted from the recipient information 53.

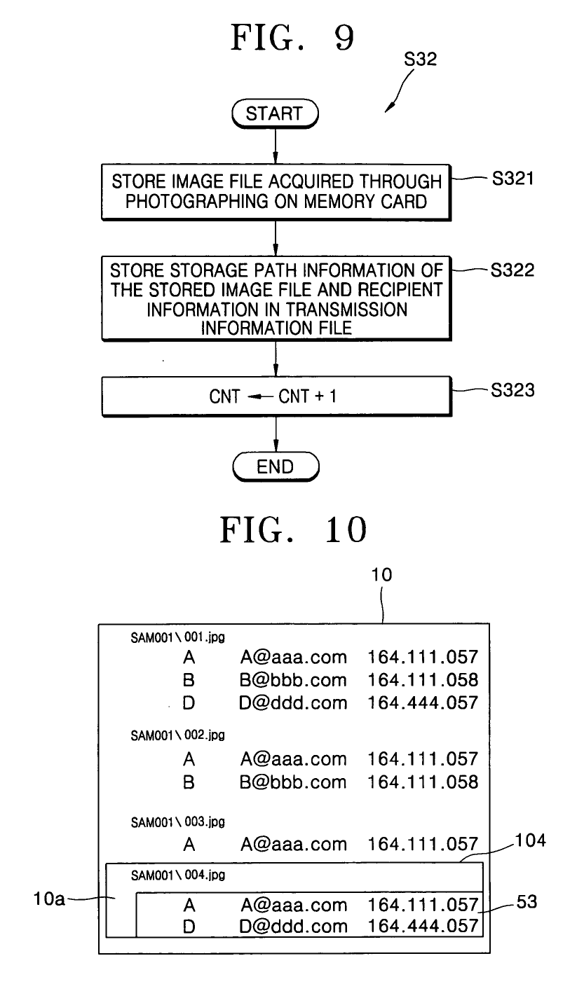

The photographing mode program executed in step S3 shown in FIG. 2 will be described with reference to FIGS. 1, 2, and 8 through 11. A photographing program is executed in step S31. The photographing program starts when a user presses a shutter button and finally acquires a digital image file.

Next, a storage control program is executed in step S32. More specifically, the image file acquired through photographing is stored in the memory card 1a in step S321. Transmission information 104 of the stored image file, i.e., storage path information 10a and the recipient information 53, is stored in the transmission information file 10, e.g., a “sendimage.dat” file, in a folder, e.g., a “Temp” folder, of the memory card 1a in step S322. The number CNT of transmission information items is incremented in step S323.

Next, the transmission control program is executed in step S21. The transmission control program has been described with reference to FIG. 4. As described above, since the transmission control program is included in the photographing mode program, an image file acquired through photographing can be immediately transmitted when the digital camera 1 is connected to a communication network in the photographing mode.

In a method of controlling a digital camera according to the present invention, stored image file path information and recipient information to which the image file is to be sent are stored in the digital camera. In addition, when the digital camera is connected to a communication network in the photographing or menu mode, the image file is transmitted to the recipient. Accordingly, a user can conveniently operate the digital camera and quickly send image files stored in the digital camera via e-mail.

Although only a few embodiments of the present invention have been shown and described, it will be understood by those skilled in the art that changes may be made to these elements without departing from the spirit and scope of the invention defined in the appended claims and their equivalents.

What is claimed is:

1. A method of controlling a digital camera, the method comprising:
allowing a user to select at least one recipient from an electronic mail address book;
storing storage path information regarding a stored photographic image file in a transmission information file;
storing recipient information for the at least one selected recipient in the transmission information file; and
transmitting the image file to the recipient according to the storage path information and the recipient information.

2. The method of claim 1, the method further comprising:
allowing a user to enter and edit electronic mail address information.

3. The method of claim 2, wherein the user enters and edits electronic mail address information via a separate digital editing apparatus that transmits the electronic mail address information to the digital camera.

4. The method of claim 2, wherein the digital camera comprises a controller that stores the electronic mail address information.

5. The method of claim 2, the method further comprising:
allowing a user to create groups of electronic mail addresses; and
allowing a user to edit group information.

6. The method of claim 5, wherein the group information comprises an index of locations where electronic mail address information in the group is stored.

7. The method of claim 1, wherein the data of the electronic mail address book and the recipient information are stored in a first data file, and the storage path information and the recipient information are stored in a second data file.

8. The method of claim 1, further comprising:
using the digital camera to acquire a photographic image; and
storing the image in a photographic image file.

9. The method of claim 1, further comprising:
allowing a user to delete recipient information from at least one memory location.

10. The method of claim 1, wherein the step of transmitting the image file further comprises:
(a) detecting the number of transmission information items in the transmission information file;
(b) transmitting a single image file;
(c) deleting the information item corresponding to the transmitted image file from the transmission information file; and
(d) decrementing the count of the number of transmission information items in the transmission information file.

11. The method of claim 1, wherein the method further comprises:
determining whether the digital camera is connected to a communication network.

12. The method of claim 1, wherein the method further comprises:
after storing storage path information and recipient information for the image file in the transmission file, incrementing the count of the number of transmission information items in the transmission information file.

13. The method of claim 1, wherein an image file is immediately transmitted to selected recipients after the image file is acquired by the digital camera.

14. The method of claim 1, wherein the data of the electronic mail address book information, the storage path information, and the recipient information are stored by the digital camera.

15. The method of claim 1, wherein the data of the electronic mail address book information, the storage path information, and the recipient information are stored on a memory card which can be inserted into and removed from the digital camera.

16. A digital camera capable of transmitting digital images, the camera comprising:
an image photographing portion to photograph an object;
an image processing portion to perform predetermined image processing and output the processed digital image data;
a display;
a user input portion that allows a user to select at least one recipient from an electronic address book;
a controller that manages the storing of storage path information regarding a stored photographic image file in a transmission information file and the storing of recipient information for the at least one selected recipient in the transmission information file, and that manages the transmission of digital image data;
a recording portion to store the digital image data, electronic mail address book information, storage path information, and recipient information; and
a communication interface for connecting to a communication network, and allowing for transmission of digital image data to recipients.

17. The digital camera of claim 16, wherein the controller includes a transmission control program that comprises:
detecting the number of transmission information items in the transmission information file;
transmitting a single image file;
deleting the information item corresponding to the transmitted image file from the transmission information file; and
decrementing the count of the number of transmission information items in the transmission information file.

18. The digital camera of claim 16, wherein the camera is connectable to a digital editing apparatus.

19. The digital camera of claim 16, wherein the digital editing apparatus transmits electronic mail address information to the digital camera.

20. The digital camera of claim 16, wherein the recording portion is a memory card.
